(19) United States
(12) Patent Application Publication
(10) Pub. No.: US 2004/0049374 A1
(43) Pub. Date: Mar. 11, 2004

(54) Translation aid for multilingual Web sites

(75) Inventors: Franklin Charles Breslau, Teaneck, NJ (US); John Paul Kaemmerer, Pflugerville, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/235,685

(22) Filed: Sep. 5, 2002

(51) Int. Cl. G06F 17/28

(52) U.S. Cl. 704/2

(57) ABSTRACT

A method, apparatus, and computer instructions to aid translation verification of a document in a base language to a target language. A debug document is displayed in which the debug document contains a set of elements in the base language to be translated to the target language. An element within the set of elements includes a file identifier of a file, a tag, and base language text. The debug file, containing text with tags, is displayed in which the tag displayed in the debug document is used to locate a portion of the text associated with the element in the file. A translation of the portion of text in the file is received to form target language text for the element.

### BACKGROUND OF THE INVENTION

1. Technical Field

The present invention relates generally to an improved data processing system, and in particular, to a method and apparatus for checking the accuracy of translated text. Still more particularly, the present invention provides a method and apparatus for translating text into different languages for use in Web pages.

2. Description of Related Art

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL.

The Internet also is widely used for commerce. Individual consumers and business use the Web to sell and purchase various goods and services. In offering goods and services, some companies offer goods and services solely on the Web while others use the Web to extend their reach. In reaching users on a global basis, businesses and other organizations often create Web sites that are multilingual. In other cases, the Web site may be designed for a single language in a targeted market. A user visiting a Web site may be asked to select a particular language.

In creating multilingual Web sites, a great amount of effort is used in generating appropriate translations for respective languages. With the translations, an application is typically used in which the application supports multiple languages for presentation to different users who may visit the Web site. Typically, an application that can support multiple languages uses data files which contain tags for the respective languages. That is, the program uses a record of some sort to store the language that should be used by the application. When the application executes, the application performs a table look-up based on a tag number in conjunction with a language locale selection to determine which characters should be inserted into the various elements used by the program that are displayed that are language sensitive. In this case, it is extremely difficult to track which tag numbers correspond to a particular language element as programs change and the order of tags in a separate file is not necessarily changed to maintain sequential use. This is of specific interest when Java servlet pages (JSPs) are used when only one program with a specific name can be used but multiple translations have to be used in conjunction with the program.

Further, when a new language is introduced, it is often difficult to understand the context in which individual elements are used. For example, the following sentence: “Call IBM Service for further assistance.” could be made up of three non-contiguous elements consisting of element A=“Call”, element B=“IBM Service” (which has to be stored in a separate tag because it is a link) and element C=“for further assistance.” Element A can be very hard to translate since the context in which the element is used is not readily apparent and could be confused with a program call, a telephone call, etc. In addition, static variables may come from one type of data file such as XML, while dynamic variables might come from another type of file such as a Java resource file. As an example, the “IBM Service” might become “IBM Operations” depending on the user's preferences. Having multiple types of files with translated strings can introduce further complications.

Therefore, it would be advantageous to have an improved method, apparatus, and computer instructions for aiding a user in identifying and translating elements used for displaying a page in a particular language.

### SUMMARY OF THE INVENTION

The present invention provides a method, apparatus, and computer instructions to aid translation verification of a document in a base language to a target language. A debug document is displayed in which the debug document contains a set of elements in the base language to be translated to the target language. An element within the set of elements includes a file identifier of a file, a tag, and base language text. The debug file, containing text with tags, is displayed in which the tag displayed in the debug document is used to locate a portion of the text associated with the element in the file. A translation of the portion of text in the file is received to form target language text for the element.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components used in providing a translation aid for translating documents from a base language to a target language in accordance with a preferred embodiment of the present invention;

FIGS. 4A and 4B are diagrams illustrating Web pages used for translating text in accordance with a preferred embodiment of the present invention;

FIGS. 5A and 5B are diagrams illustrating additional examples of documents used in translating a base language into different languages for a Web site in accordance with a preferred embodiment of the present invention;

FIGS. 6A and 6B are portions of example files containing translations and a debug file in accordance with a preferred embodiment of the present invention;

FIG. 7 is a flowchart of a process used for translating text from a base or debug language to a target language in accordance with a preferred embodiment of the present invention; and

FIG. 8 is a flowchart of a process used for translating text from a base language to a target language in accordance with a preferred embodiment of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer or any display devices capable of displaying browser output, such as cell phones, pagers, PDAs, etc. Computer 100 also preferably includes a graphical user interface (GUI) that may be implemented by means of systems software residing in computer readable media in operation within computer 100.

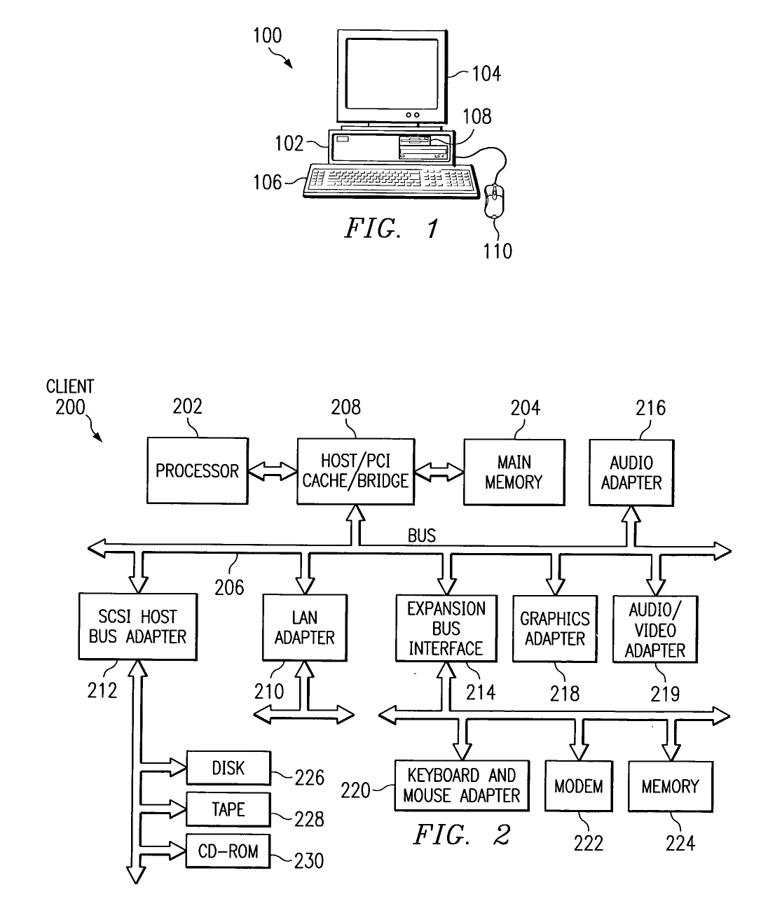

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. Instructions for the operating system and the applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

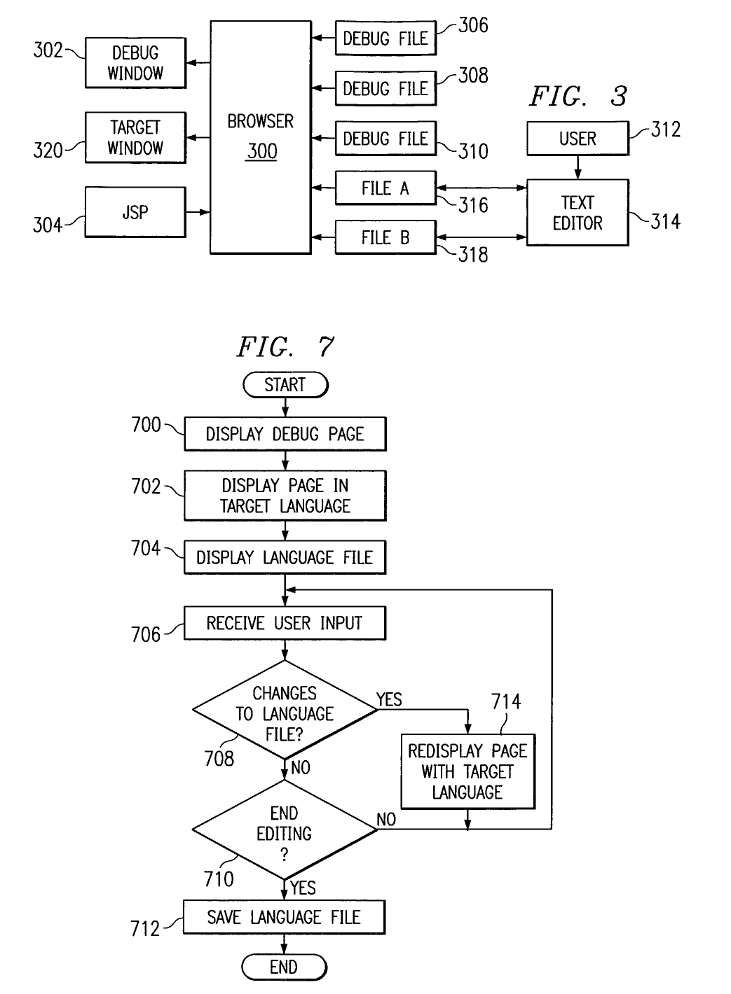

With reference now to FIG. 3, a diagram illustrating components used in providing a translation aid for translating documents from a base language to a target language is depicted in accordance with a preferred embodiment of the present invention. In this example, the components illustrated are used to display a document or Web page in a special test language as well as receive user input generating translations to a target or desired language.

Specifically, browser 300 is employed to display a page in a special test or base language in which identification of files and tags within files are presented within the page displayed by the browser in a window, such as debug window 302. In this example, Java Server Page (JSP) 304 is displayed in debug window 302 using information from debug file 306. Of course, multiple files, such as debug files 308 and 310, may be used in the translation process. For example, “(B30) Call (A15)IBM Service (B31)for further assistance.” is displayed in debug window 302. This presentation indicates that the translation for the word “Call” can be found in the tag number 30 of file B. The translation for the link “IBM Service” is found in tag number 15 of file A. The translation for the element “for further assistance” may be found in file B in tag number 31. This element is also referred to as a translation element. An element, as used herein, may be, for example, a single word, a phrase, a link, an entire sentence, or multiple sentences.

The information, including the file and tag identifiers within the file, is stored in debug file 306. User 312 may view debug window 302 and select the appropriate file for translation using text editor 314. In the illustrated example, the different elements are located in file A 316 and file B 318. In translating the element “Call”, user 312 will open file B 318 based on the identifier presented in debug window 302. The particular element is identified as tag number 30. With this tag number, user 312 may locate the appropriate element within file B 318 for translation through text editor 314. Next, the element “for further assistance” also is located within file B 314 and is located using tag number 31. The element “IBM Service” is found in file A 316 and is located within the file through the use of tag number 15.

When user 312 enters translations for these elements using text editor 314, the translated language text is stored back into file A 316 or file B 318 in these examples. As a further aid, changes made by the user may be displayed in target window 320. In this instance, translated text or text in the target language is pulled from language files, such as file A 316 and file B 318, by JSP 304 for display within target window 320. In this manner, user 312 may view debug window 302 and compare its contents with target window 320. Thus, user 312 may see the debug language version of the page, which is in the base language, and compare it with the translated version of the page in the target language. Note that a tag may be left blank, e.g., if no hot link is desired, if the hot link should be at the beginning of the sentence or the hot link should be at the end of the sentence.

Browser 300 may be implemented using any known browser, such as, for example, Internet Explorer, which is available from Microsoft Corporation. Further, text editor 314 may be implemented using any text editor, such as Microsoft Word or WordPad. These two text editors are available from Microsoft Corporation. The files in which elements may be located may vary depending on the particular implementation. For example, a file may be a Java resource bundle, an extensible markup language (XML) file, or even a straight text file, or even read from a database. In this example, only a single debug file, debug file 306, is shown. Depending on the particular implementation, multiple files may be used. Even translation strings feeding into a Web displayed portal from other tools may have their streams encoded for the new debug language.

In this example, user 312 may open and close files through text editor 314 and identify files containing elements based on viewing the debug version of the page containing the identifiers for each element. This example requires no changes to existing browsers and text editors. Additionally, additional aids may be provided to user 312 by providing the elements in association with links. Selection of a link for an element automatically causes text editor 314 to open the file containing the element and display the element. In this implementation, user 312 is not required to have knowledge of file locations and may simply focus on translating text in the elements. A specialized text editor may be employed such that after the entry of each translation, the translated page displayed in target window 320 is updated to reflect the updated text.

In the depicted example in FIG. 3, the document is displayed using browser 300 with the user performing edits through text editor 314. These examples are not meant as architectural limitations to the present invention. For example, other programs used to display Web pages or Java applets may be used other than the particular type of browser described for browser 300.

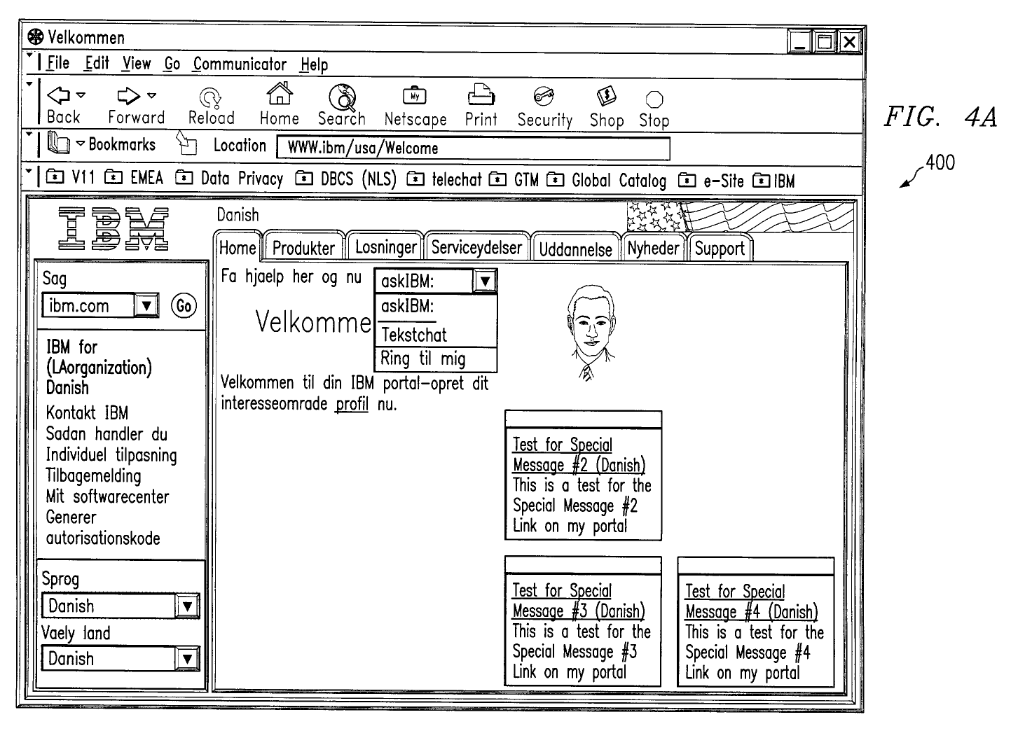

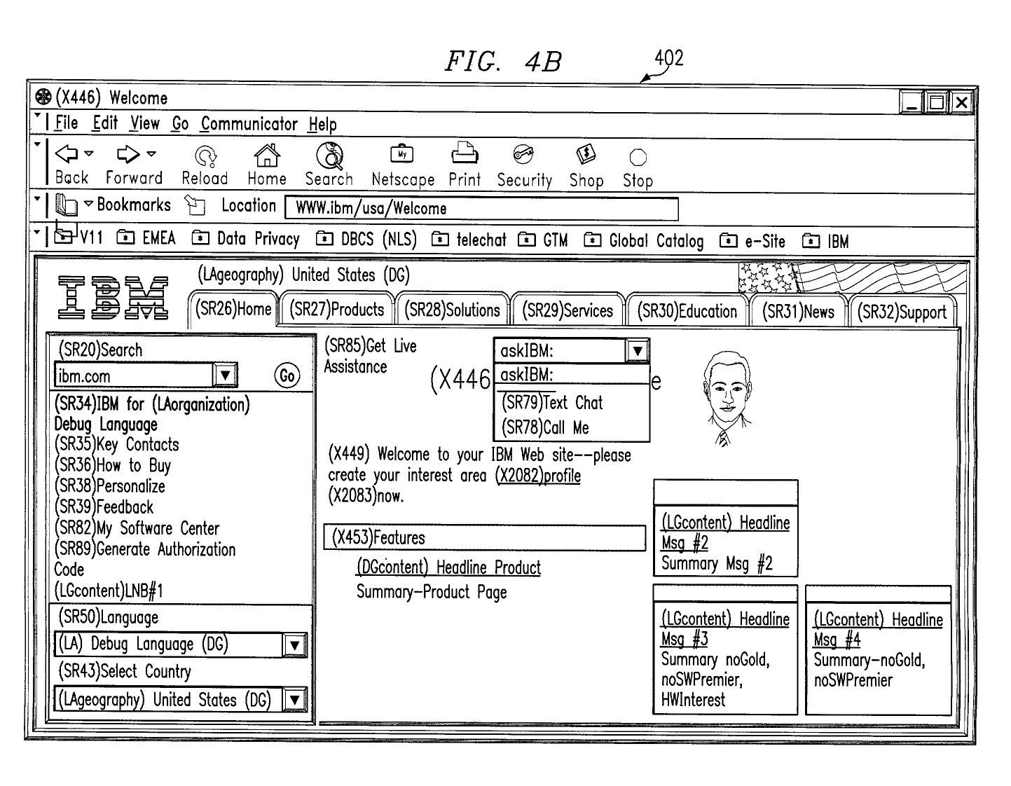

Turning now to FIGS. 4A and 4B, diagrams illustrating Web pages used for translating text are depicted in accordance with a preferred embodiment of the present invention. In this example, Web page 400 in FIG. 4A is presented in the target language, Danish, while Web page 402 in FIG. 4B is presented in the base or debug language, English. Web page 400 is displayed in a browser window such as target window 320 in FIG. 3 while Web page 402 is displayed in a browser window such as debug window 302 in FIG. 3. As can be seen, Web page 402 includes file and tag identifiers located between parenthesis. These identifiers are associated with the elements that are to be translated from a base language to a target language. Of course, the visual identifiers in Web page 402 may be replaced with or supplemented with links allowing the appropriate file to be opened at the appropriate location for translations.

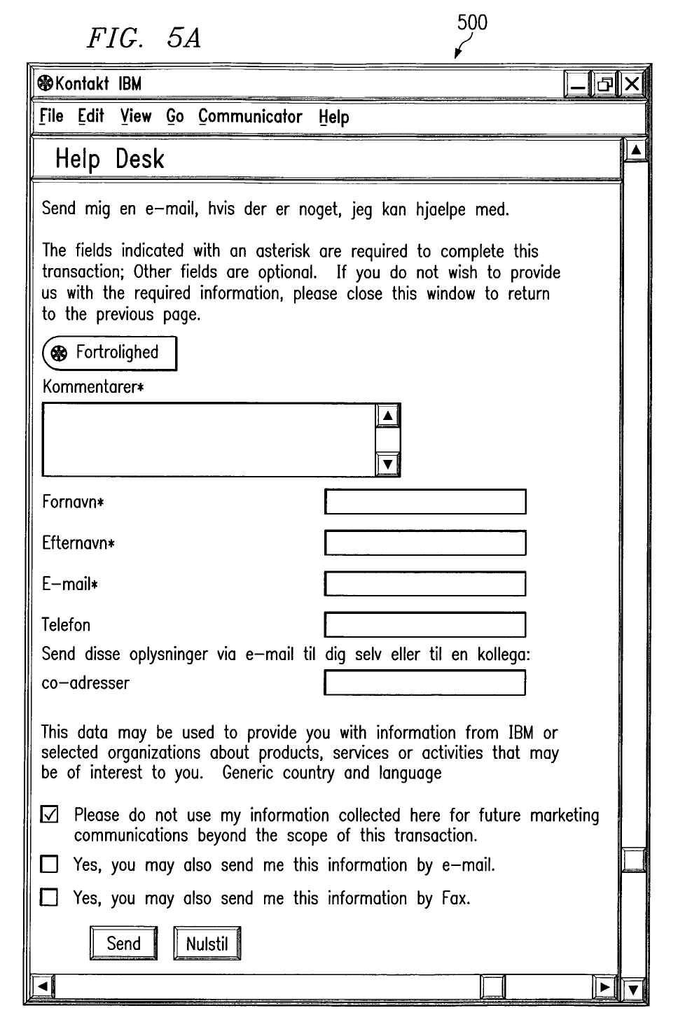

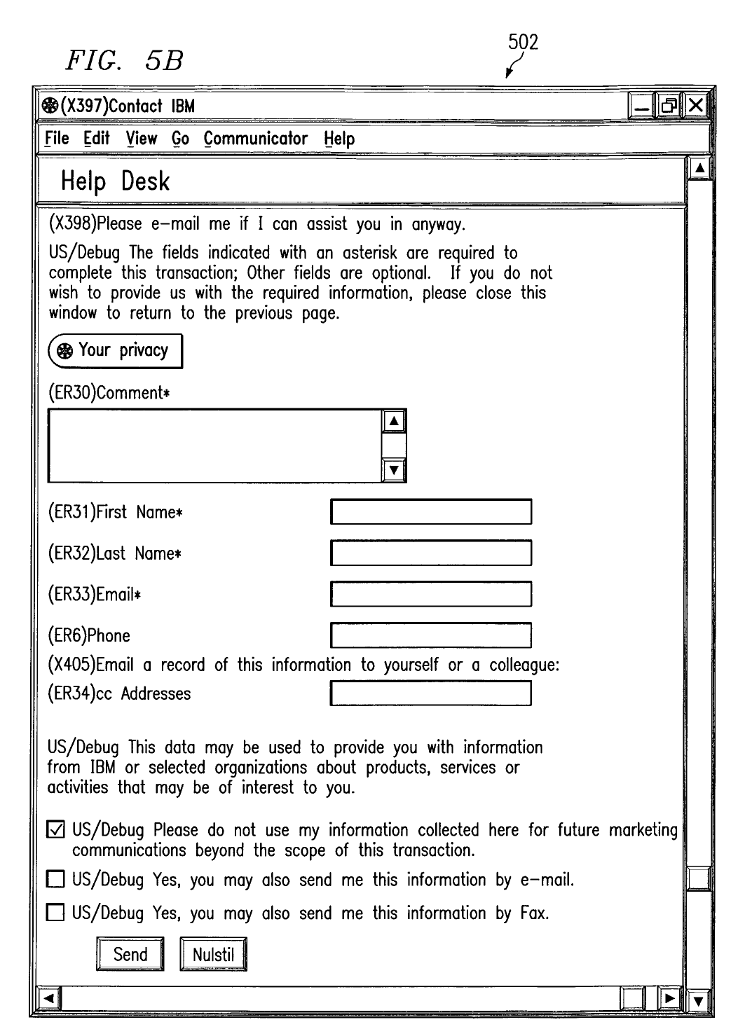

With reference now to FIGS. 5A and 5B, diagrams illustrating additional examples of documents used in translating a base language into different languages for a Web site are depicted in accordance with a preferred embodiment of the present invention. In this example, page 500 in FIG. 5A is in a target language, Danish, while page 502 in FIG. 5B is in the base or debug language, English. Page 500 is displayed in target window 320 in FIG. 3. Page 502 is displayed in debug window 302 in FIG. 3. With the use of the two windows for displaying the debug page and a target language page, a user may easily compare translations to determine whether additional changes need to be made.

As can be seen by these illustrations, individual strings or elements and the source of the strings and elements may be identified, allowing for more accurate translations. By being able to see the context in which individual strings or elements are used, confusion or improper translations may be minimized. Additionally, the ability to employ two browser windows to show the base or source language for comparison with the target language allows for quick comparisons.

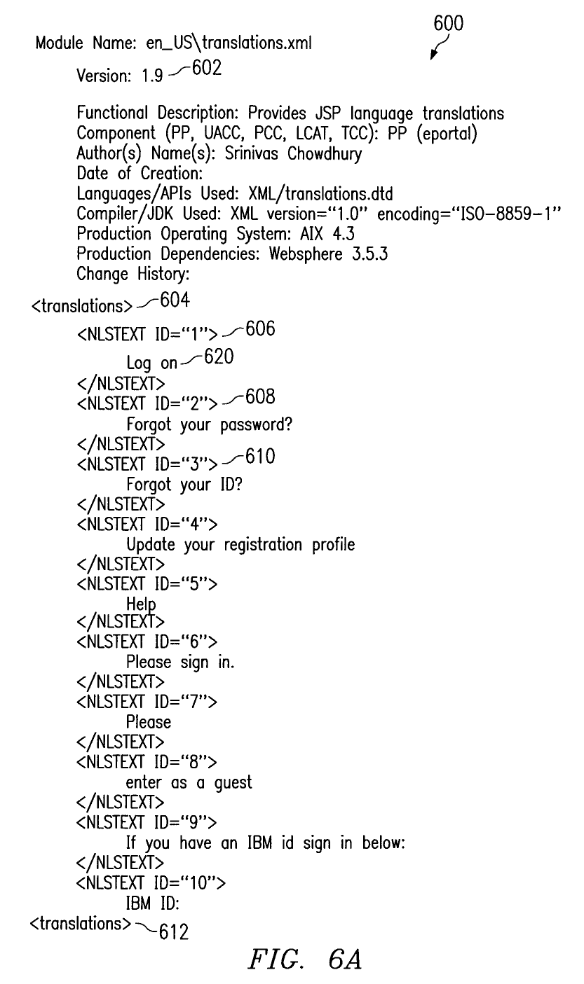

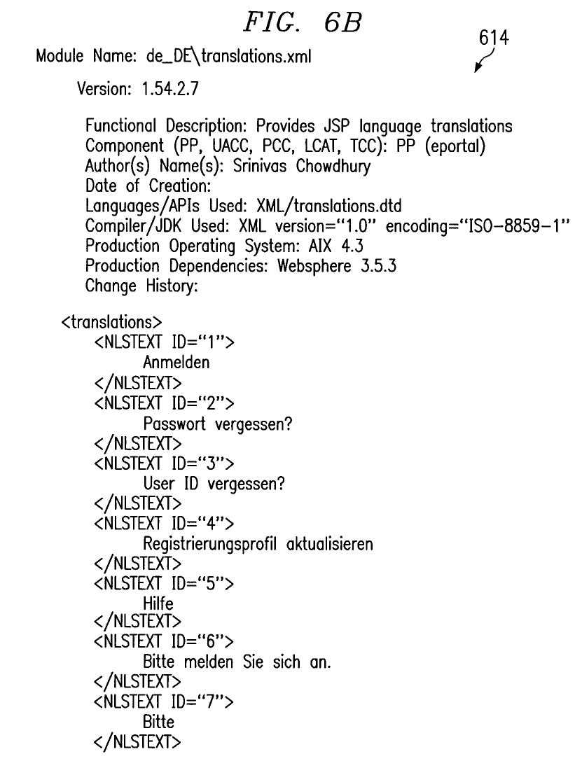

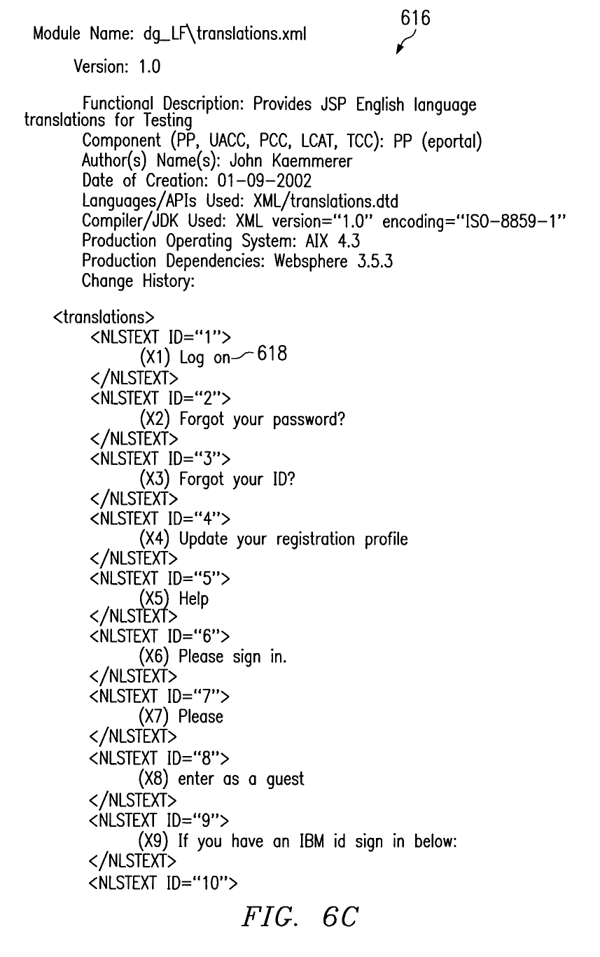

Turning now to FIGS. 6A-6C, portions of example files containing translations and a debug file are depicted in accordance with a preferred embodiment of the present invention. In this example, file 600 in FIG. 6A is an example of a file, which may be used in file A 316 or file B 318 in FIG. 3. Although any type of file may be used, this particular example employs an XML file. In this particular example, file 600 is in the source language, English. File 600 includes an XML version statement in line 602. Translations tag 604 indicates the beginning of string or element translations. Tags, such as tags 606, 608, and 610 include tag numbers, which correspond to those displayed in the base or debug page. The text between start and end NLSTEXT tags identify elements that are to be translated. Translations tag 612 indicates the end of the file in this example.

File 614 in FIG. 6B is an example of file 600 with translations into the target language. File 614 is the file created or edited by the user in the target language. File 614 is the file that will be used by the servlet, such as JSP 304 in FIG. 3, to display a Web page in the target or selected language. By the selection of different XML files in different target languages, the same JSP may be used to display a Web page in different languages.

File 616 in FIG. 6C is an example of debug file, such as debug file 306 in FIG. 3. This file is similar to file 600 in FIG. 6A, except the text also includes a file and tag identifier. For example, line 618 in file 616 is identical to line 620 in file 600 except the file and tag identifier “(X1)” is added to the text for a user performing translations to identify the file and the tag in the file. The file is identified by “X”, while the tag is identified by the numeral “1” in this example.

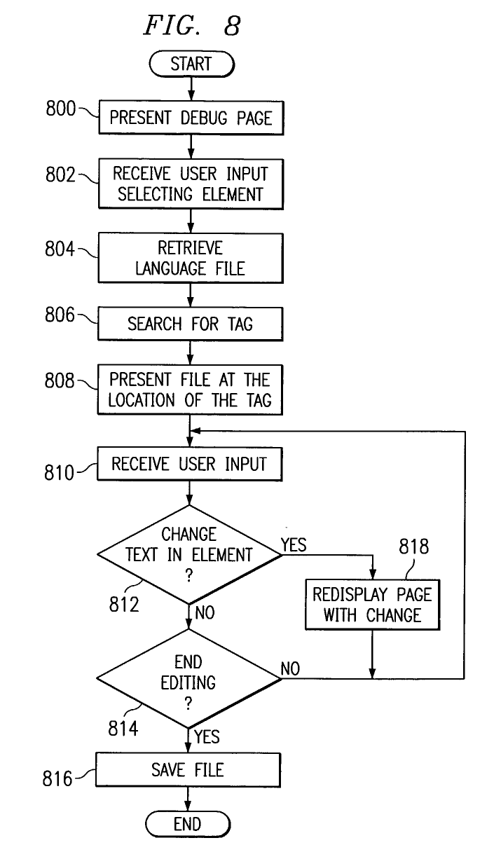

Turning now to FIG. 7, a flowchart of a process used for translating text from a base or debug language to a target language is depicted in accordance with a preferred embodiment of the present invention. The process illustrated in FIG. 7 may be implemented in a data processing system, such as data processing system 200 in FIG. 2.

The process begins by displaying the debug page (step 700). This debug page is displayed in a window, such as debug window 302 in FIG. 3. The page is displayed in the target language (step 702) and the language file is displayed (step 704). The page in the target language is displayed in a window such as target window 320 in FIG. 3. Of course, before any translations are entered by the user, this page actually contains text elements in the base language. The language file is, in this example, an XML file, such as file 600 in FIG. 6. This file is displayed or opened for editing through a text editor, such as text editor 314 in FIG. 3. The appropriate file is selected based on identifiers presented on the debug page.

User input is received (step 706). Next, a determination is made as to whether the user input makes changes to the language file (step 708). If the user input does not make changes to the language file, a determination is made as to whether the user input indicates that editing should end (step 710). If the user input indicates that editing is to end, the language file is saved (step 712) and the process terminates thereafter.

Returning again to step 710, if user input indicates that editing is not to end, the process returns to step 706 as described above. With reference again to step 708, if the user input changes content in the language file, the page is redisplayed with the target language (step 714), and the process returns to step 706 as described above. This updated display of the page using the target language is initiated by the user in this particular example. For example, the user may refresh the page, causing the changes made to be displayed when the page is refreshed from the language file containing the changes.

With reference now to FIG. 8, a flowchart of a process used for translating text from a base language to a target language is depicted in accordance with a preferred embodiment of the present invention. The process illustrated in FIG. 8 may be implemented in a data processing system, such as data processing system 200 in FIG. 2. The steps illustrated in this example may be implemented within a browser, a text editor, or as a separate component. This particular example provides additional features to aid the user in identifying appropriate elements for translation.

The process begins by presenting a debug page (step 800). This debug page is displayed in a window, such as debug window 302 in FIG. 3. This debug page may contain visual identifiers identifying a file and element location. In this particular example, a link is employed to allow for retrieval of the file at the location of the element that is to be translated. This debug page is in a base language, such as English.

User input selecting an element for translation is received (step 802). The language file is retrieved (step 804). The appropriate language file is identified in the link selected by the user. After the language file has been retrieved, a search for the tag identifying the element in the file is performed (step 806). The file is presented at the location of the tag (step 808).

Thereafter, user input is received (step 810). A determination is made as to whether the text in the element has changed (step 812). If the text in the element has not changed, a determination is made as to whether the user input indicates that editing is to end (step 814). If the user input indicates that editing is to end, the file is saved (step 816) and the process terminates thereafter.

With reference again to step 814, if the user input indicates that editing is not to end, the process returns to step 810 as described above. Referring again to step 812, if the text in the element has changed, the page is redisplayed with the change (step 818) and the process returns to step 810 as described above. This page is in the target language and displayed in the target window 320 in FIG. 3.

Thus, the present invention provides an improved translation aid for translating documents. More specifically, the present invention described above provides an improved method, apparatus, and computer implemented instructions for translating documents from a base language to a target language in which context for different elements may be easily identified. The mechanism of the present invention is particularly useful in creating multilingual Web sites. The verification of translations are speeded up by not only providing a base language from where the translation is derived but also providing a location from where particular elements are stored. In these examples, a visual identifier is provided. Additionally, a link may be used to retrieve the file at the appropriate location within the file. In these examples, the user codes directly into the file that is to be used to present the pages. Through the use of dual windows in presenting the debug language version and target language version of the page, quick comparisons may be made by the user in translating the elements.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. In these examples, the mechanism of the present invention is applied to translations of text to be used in a Web page. The mechanism of the present invention also may be applied for use with graphic images. A graphic editor may be employed in addition to a text editor to add the name of a file for a particular graphic image depending on the target language, such that the graphic image may be changed for different languages. Further, the translations in these examples are located in an XML file. Other types of files may be used depending on the implementation, such as, for example, a servlet resource file, a database table, and a Java resource file. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for translating a document in a base language to a target language, the method comprising:
displaying a debug document, wherein the debug document contains a set of elements in the base language to be translated to the target language, wherein an element within the set of elements includes a file identifier of a file, a tag, and base language text;
displaying the file containing text with tags, wherein the tag displayed in the debug document is used to locate a portion of the text associated with the element in the file; and
receiving a translation of the portion of text in the file to form target language text for the element.

2. The method of claim 1 further comprising:
displaying a translated document using the file containing the target language text.

3. The method of claim 1, wherein the file is an extensible markup language file, a servlet resource file, a database table, or a Java resource file.

4. A method in a data processing system for translating text for multilingual documents, the method comprising:
displaying a base language document, wherein the base language document contains a set of set of strings to be translated to a target language, in which a string within the set of strings includes text in a base language and an identification of a location of a translation element;
displaying a file containing the translation element corresponding to the string in the base language document; and
receiving a translation of text in the translation element to form translated text in the target language.

5. The method of claim 4 further comprising:
displaying a translated document containing the translated text.

6. The method of claim 4, wherein the translation element includes a tag and the text.

7. The method of claim 4, wherein the identification comprises a file identifier and tag.

8. The method of claim 4, wherein the identification is a link to text in a file corresponding to the translation element.

9. The method of claim 4, further comprising:
displaying the translation element in the file in response to a selection of the link.

10. The method of claim 4, wherein the base language document is a Web page.

11. The method of claim 4, wherein the file is an extensible markup language file, a serviet resource file, a database table, or a Java resource file.

12. The method of claim 4, wherein the base language document is displayed using a browser and the file is displayed using a text editor.

13. The method of claim 4, wherein the set of strings to be translated into the target language are located in a plurality of different files.

14. The method of claim 4, wherein the set of strings also includes a file name for a graphics file and wherein the translation of the text includes another file name for another graphics file for the target language.

15. The method of claim 14, wherein the graphics file is displayed using a graphics editor.

16. A data processing system for translating a document in a base language to a target language, the data processing system comprising:
a bus system;
a communications unit connected to the bus system;
a memory connected to the bus system, wherein the memory includes a set of instructions; and
a processing unit connected to the bus system, wherein the processing unit executes the set of instructions to display a debug document in which the debug document contains a set of elements in the base language to be translated to the target language in which an element within the set of elements includes a file identifier of a file, a tag, and base language text; display the file containing text with tags in which the tag displayed in the debug document is used to locate a portion of the text associated with the element in the file, and receive a translation of the portion of text in the file to form target language text for the element.

17. A data processing system for translating text for multilingual documents, the data processing system comprising:
a bus system;
a communications unit connected to the bus system;
a memory connected to the bus system, wherein the memory includes a set of instructions; and
a processing unit connected to the bus system, wherein the processing unit executes the set of instructions to display a base language document in which the base language document contains a set of set of strings to be translated to a target language, in which a string within the set of strings includes text in a base language and an identification of a location of a translation element; display a file containing the translation element corresponding to the string in the base language document; and receive a translation of text in the translation element to form translated text in the target language.

18. A data processing system for translating a document in a base language to a target language, the data processing system comprising:
first displaying means for displaying a debug document, wherein the debug document contains a set of elements in the base language to be translated to the target language, wherein an element within the set of elements includes a file identifier of a file, a tag, and base language text;
second displaying means for displaying the file containing text with tags, wherein the tag displayed in the debug document is used to locate a portion of the text associated with the element in the file; and
receiving means for receiving a translation of the portion of text in the file to form target language text for the element.

19. The data processing system of claim 18, wherein the displaying means is a first displaying means and further comprising:
second displaying means for displaying a translated document using the file containing the target language text.

20. The data processing system of claim 18, wherein the file is an extensible markup language file, a servlet resource file, a database table, or a Java resource file.

21. A data processing system for translating text for multilingual documents, the data processing system comprising:
first displaying means for displaying a base language document, wherein the base language document contains a set of set of strings to be translated to a target language, in which a string within the set of strings includes text in a base language and an identification of a location of a translation element;
second displaying means for displaying a file containing the translation element corresponding to the string in the base language document; and
receiving means for receiving a translation of text in the translation element to form translated text in the target language.

22. The data processing system of claim 21, wherein the displaying means is a first displaying means and further comprising:
second displaying means for displaying a translated document containing the translated text.

23. The data processing system of claim 21, wherein the translation element includes a tag and the text.

24. The data processing system of claim 21, wherein the identification comprises a file identifier and tag.

25. The data processing system of claim 21, wherein the identification is a link to text in a file corresponding to the translation element.

26. The data processing system of claim 21, wherein the displaying means is a first displaying means and further comprising:
third displaying means for displaying the translation element in the file in response to a selection of the link.

27. The data processing system of claim 21, wherein the base language document is a Web page.

28. The data processing system of claim 21, wherein the file is an extensible markup language file, a servlet resource file, a database table, or a Java resource file.

29. The data processing system of claim 21, wherein the base language document is displayed using a browser and the file is displayed using a text editor.

30. The data processing system of claim 21, wherein the set of strings to be translated into the target language are located in a plurality of different files.

31. The data processing system of claim 21, wherein the set of strings also includes a file name for a graphics file and wherein the translation of the text includes another file name for another graphics file for the target language.

32. The data processing system of claim 31, wherein the graphics file is displayed using a graphics editor.

33. A computer program product in a computer readable medium for translating a document in a base language to a target language, the computer program product comprising:
first instructions for displaying a debug document, wherein the debug document contains a set of elements in the base language to be translated to the target language, wherein an element within the set of elements includes a file identifier of a file, a tag, and base language text;
second instructions for displaying the file containing text with tags, wherein the tag displayed in the debug document is used to locate a portion of the text associated with the element in the file; and
third instructions for receiving a translation of the portion of text in the file to form target language text for the element.

34. A computer program product in a computer readable medium for translating text for multilingual documents, the computer program product comprising:
first instructions for displaying a base language document, wherein the base language document contains a set of set of strings to be translated to a target language, in which a string within the set of strings includes text in a base language and an identification of a location of a translation element;
second instructions for displaying a file containing the translation element corresponding to the string in the base language document; and
third instructions for receiving a translation of text in the translation element to form translated text in the target language.
